(19) United States
(12) Patent Application Publication
(10) Pub. No.: US 2009/0121835 A1
(43) Pub. Date: May 14, 2009

(54) Communications Device, Apparatus and System

(76) Inventors: Marc Borret, Gloucestershire (GB); Colin Brooks, Gloucestershire (GB); Andrew Hills, Gloucestershire (GB); Heikki Huomo, Gloucestershire (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/886,530

(22) PCT Filed: Mar. 20, 2006
(86) PCT No.: PCT/GB06/00990

§ 371 Date: May 30, 2008

(30) Foreign Application Priority Data
Mar. 18, 2005 (GB) 0505640.3
Mar. 22, 2005 (GB) 0505868.0
Mar. 6, 2006 (GB) 0604480.4

(51) Int. Cl. H04B 5/00; H04Q 5/22

(52) U.S. Cl. 340/10.1; 455/41.1

(57) ABSTRACT

A wireless near-field communications device is disclosed which comprises a first and a second near-field inductive coupling member, each of said first and second coupling member arranged to have a different coupling configuration from each other.

### FIELD

This invention relates to wireless near field communications devices, comprising dual or multiple antennas and apparatus and/or systems comprising such devices, each arranged to have a different near-field coupling configuration, for example different magnetic near-field orientation, shape or relative strength. In particular, but not exclusively, this invention relates to consumables or replaceable components for apparatus or systems incorporating such devices.

### BACKGROUND

Wireless non-contact communication systems have previously been proposed.

One such system is generally known as a near field RFID (Radio Frequency Identification) system, and employs a near field RFID tag and a near field RFID reader for reading information stored on the tag by means of magnetic field (H-field) inductive coupling between the reader and the tag. Near field RFID tags are referred to below as tags or RFID tags. Near field RFID readers are referred to below as readers or RFID readers. Readers and tags are together referred to below as RFID devices.

Such tags typically include an antenna, a controller and a memory (which may be part of the controller) in which information (for example information about the article to which the tag has been attached, control data or program data) is stored or may be stored.

For so-called passive tags, a compatible reader uses a radio frequency (RF) signal, sometimes referred to as a carrier signal, (for example a signal at 13.56 MHz) to generate a magnetic field and when the antenna of the tag is in close proximity to the reader the magnetic field (H-field) generated by the reader is inductively coupled from the reader to the tag resulting in derivation and supply of power to the controller. Supply of power enables operation of the tag, for example enabling the tag controller to operate and access the memory and transmit information from the memory via the tag antenna to the reader. Transmission of information from the memory will be through modulation of the supplied magnetic field (H field). In this context a compatible reader is a reader operating at the same or a similar radio frequency as the tag and in accordance with the same communication protocols.

RFID readers typically include an antenna, controller, memory (which may form part of the controller), signal generator, modulator (for modulating a generated RF signal with data from either the controller and/or memory) and demodulator (for demodulating a modulated RF signal received from for example a tag.

Illustrative RFID devices are described in various international standards, for example ISO/IEC 14443 and ISO/IEC 15693.

In addition to RFID devices of the types described above, it has also previously been proposed to provide so-called Near Field Communications (NFC) devices.

NFC devices, often referred to as NFC communicators (which two terms may be used interchangeably), are radio frequency non-contact communications devices that can communicate wirelessly with other NFC devices and/or RFID devices over relatively short ranges (for example a range in the order of several centimetres up to a maximum range of in the order of a metre or so). Communication is via inductive coupling of a magnetic field (H field) between the NFC device and a second NFC device or RFID device.

Illustrative NFC devices and systems are described in ISO 18092 and ISO 21481, and the operation of NFC devices depends on whether they are operating as an “initiator” or a “target”, and whether they are operating in a “passive communications mode” or an “active communications mode”. As will be apparent from the following, the terms “passive” and “active” in the context of NFC devices do not have the same meaning as “passive” and “active” when used in the context of traditional RFID devices.

An initiator NFC device will generate an RF field and start communication. A target device will respond to receipt of an RF field from an Initiator NFC device. Response will be through modulation of the supplied RF field or through generation of a new RF signal and modulation of that RF signal.

In a “passive communications mode” the initiator NFC Device will generate an RF field and the Target NFC device will respond to an initiator command by modulation of the received RF signal, usually by load modulation. In an “active communications mode” both the initiator NFC device and the target NFC device use their own RF field to enable communication.

It will be apparent from the foregoing that a first NFC device can operate in a passive mode (in a manner akin to a conventional RFID tag) and use an RF field generated by a conventional RFID reader or a second NFC device to respond to that reader or second NFC device. Alternatively, the first NFC device can operate in an active mode to generate an RF field for interrogating a conventional RFID tag or for communication with a second NFC device that may be operating in a passive or an active mode (i.e. either by using the RF field generated by the first device to communicate with the first device or by generating its own RF field for communication with the first device).

This allows such NFC devices to communicate with other NFC devices, to communicate with RFID tags and to be ‘read’ by RFID readers.

NFC and RFID devices may be in stand-alone form (either hand-held or free-standing) or comprised within a system (either in stand-alone form or by being integrated within the system), for example a mobile transceiver (such as a mobile telephone or cellphone), a personal digital assistant (PDA), IPOD®, portable music players, an item of computer equipment such as a personal or portable computer, other electrical devices or a vending machine. NFC or RFID devices can be implemented by means of a single integrated circuit (a so-called one-chip solution or system on chip) and/or optionally by means of separate functional component parts or separate integrated circuits.

Conventionally, NFC devices and RFID readers have one antenna which is used to inductively couple a magnetic field to the antenna of a second RFID or NFC device with which the first NFC device or RFID device is communicating. This means that such devices are only able to communicate with one other device at any one time and at a pre-determined range. That is to say, at a range for which the antenna was designed. NFC devices and RFID readers have systems to control which devices communicate where multiple devices are in range. Due to the constraints of the antennas utilised with such devices this means that NFC devices and RFID devices tend to communicate at set ranges and in set communication formats for example as set down in various standards such as ISO/IEC 14443 and ISO/IEC 15693. This means that such devices and readers are not flexible as to the format of devices with which they can communicate. In addition all communicating devices must use the same protocols or the NFC device or RFID reader must cycle through several protocols to assess whether there are compatible devices within range.

End system apparatus, such as consumer products, are now being sold which are useable with a broad range of disposables or component parts. It is important for manufacturers and suppliers of such apparatus to be able to control the operational parameters of the apparatus and its functionality both as regards the disposables or components parts used and external factors, such as commercial factors. It is also important that in developing apparatus which are able to operate with a wide variety of disposables and component parts that manufacturing cost does not escalate, both in terms of the manufacturing cost of the apparatus and the cost of the disposable or component part. It is also important that any replaceable parts are manufactured to be compatible with the end system and to be safe during operation. Finally it is advantageous if any such apparatus can be programmed post manufacture whilst the apparatus remains within its packaging.

Aspects and embodiments of the invention were devised with the foregoing in mind.

### SUMMARY

Viewed from a first aspect the present invention provides a wireless near-field communications device which comprises a first and a second near-field inductive coupling member. Each of the first and second coupling members are arranged to have a different coupling configuration from each other. Thus, sole communication between a one of the first and second coupling members with a coupling member arranged to have the same or at least substantially similar coupling configuration to that one coupling member may be achieved. Such an environment means that different coupling members may be designed to operate for different protocols and formats.

The first coupling member may be arranged to generate a near-field having a different orientation relative to a near-field generated by the second coupling member. For example, the first coupling member may be arranged to generate a near-field having an orientation transverse, orthogonal or opposed to a near-field generated by the second coupling member. Optionally, or additionally, the first coupling member may be arranged to generate a different magnetic near-field shape from a magnetic near-field shape generated by the second coupling member. Respective complementary coupling members may be arranged to have near-field orientations or shapes which match those of the first and second coupling members, thereby providing good coupling between matched members and poor coupling, preferably no coupling at all, between unmatched members.

The first coupling member may be disposed spatially distant from the second coupling member, thereby providing for sole communication between a one of the first and second coupling members and another coupling member spatially disposed proximal thereto. The first coupling member may be arranged to generate a near field having a different near field coupling distance relative to a near field generated by the second coupling member. For example the second coupling member may be configured to have a maximum near field coupling distance of up to 1 centimetre.

A device may be an NFC device or an RFID reader.

Embodiments of the present invention may be incorporated in apparatus, and the apparatus may further comprise a second wireless near field communications device thereby providing wireless communications within the apparatus. The first coupling member is arranged to have a coupling configuration compatible with a complementary coupling member of the second wireless near field communications device, and the device is positioned in the apparatus to be operative for communication with the complementary coupling member.

In an optional embodiment the apparatus comprises a host part and a component part, where the host part includes a device such as described above and positioned in the host part such that the second coupling member is operative to couple with a complementary coupling member supported by the component part. The component part may be removable from the apparatus and may be replaceable.

Typically, the component part comprises a consumable item for the apparatus, or may be a spare part for the apparatus. For example the component part may be an ink cartridge (where the host part is a printer), a fuel cell (where the host part may be a power charger, mobile telephone, personal computer). This is a particularly useful configuration for the contactless transfer of power to the apparatus, and typically one or other or both of the devices are configured to provide for power transfer between them.

Apparatus may comprise a device such as described above, which is positioned in the apparatus such that the first coupling member is operative to communicate with circuitry within the apparatus (for example within the component part), and the second coupling member is operative to communicate with a wireless near-field inductive coupling device external to the apparatus. Alternatively the device may be positioned such that the first coupling member is operative to communicate with one component part and the second coupling member is operative to communicate with a second component part.

The coupling members may be antennas, coils or any other suitable inductive coupling mechanism.

Viewed from another aspect an end system such as an apparatus as described above can be programmed during manufacture or after manufacture through use of a RFID or NFC device comprised within or on the apparatus or a component or replaceable part of the apparatus.

In one embodiment an RFID or NFC device is attached to or comprised within the apparatus, such RFID or NFC device being programmable during or at the end of manufacture or packaging of the apparatus or following final packaging of the apparatus. In one embodiment the data stored within such RFID or NFC device is transferred to or ‘read’ by a wireless near-field communications device which comprises a plurality of near-field coupling members and which is comprised within the apparatus, such transfer or reading occurring on activation or powering up of the apparatus. The transferred or read data has an operational, functional or control affect on the apparatus.

In a particular embodiment, the apparatus is a consumer device such as a printer, whether combined with other functionalities (such as fax, telephone) or alone, a mobile telephone, personal digital assistance, personal computer or other electrical device.

In an embodiment the RFID or NFC device is an RFID transponder or RFID tag. The RFID transponder or tag may be passive i.e. without its own power supply. RFID in this context means any device using RF signals to transmit/receive and/or communicate data or instructions.

In one embodiment, the first coupling member in the apparatus is operative to communicate with a wireless near field inductive coupling device external to the apparatus.

### BRIEF DESCRIPTION OF THE DRAWINGS

FIG. 1 is a schematic illustration of an RFID device in accordance with an embodiment of the invention;

FIG. 2 is a schematic illustration of an RFID in accordance with a second embodiment of the invention;

FIG. 3 is a schematic illustration of an NFC device in accordance with an embodiment of the invention;

FIG. 4(a) is a diagrammatic representation of a fuel cell device;

FIG. 4(b) is a diagrammatic illustration of an RFID tag in the fuel cell device of FIG. 4(a);

FIG. 5 schematically illustrates the functionality found within an RFID tag in accordance with an embodiment of this invention;

FIG. 6 is a flow diagram of data between a fuel cell device, tag and electrical device in accordance with an embodiment of the invention;

FIG. 7 is a schematic illustration of an embodiment of the invention in a printer;

FIG. 8 is a flow diagram of the process steps for a manufacturing process for the printer illustrated in FIG. 7;

FIG. 9 is a schematic illustration of an ink cartridge for the printer illustrated in FIG. 7;

FIG. 10 is a schematic illustration of an ink cartridge having an inductive coupler; and

FIG. 11 is a schematic illustration of ink cartridges having further inductive coupler arrangements.

### DESCRIPTION

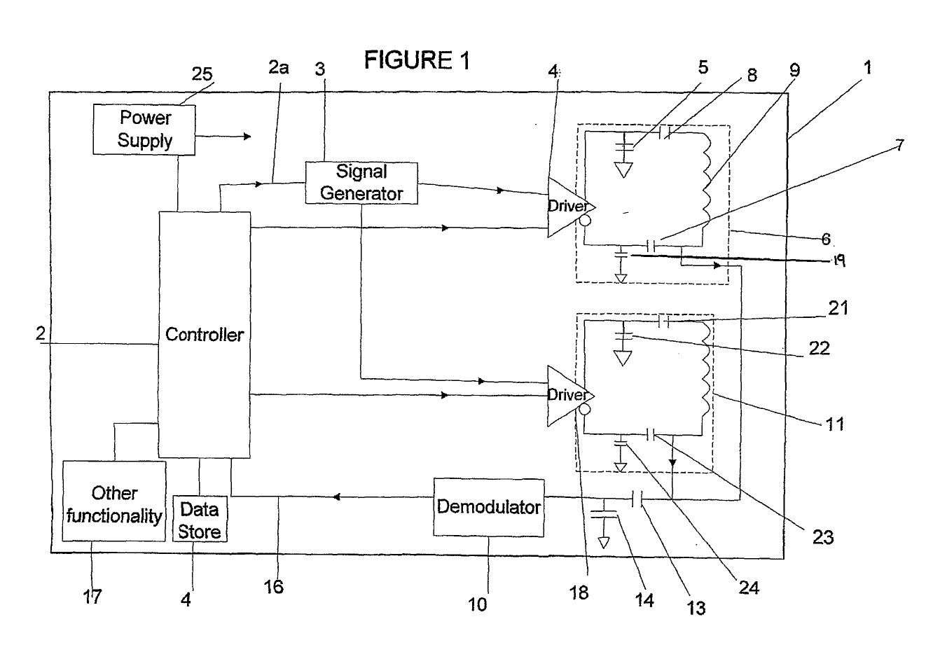

FIG. 1 shows an RFID device in accordance with one aspect of the invention. The RFID device is a reader which is operable to transmit a radio frequency signal and to receive and demodulate a modulated magnetic field. The RFID device comprises a controller 2, signal generator 3, differential driver 4, first antenna 6, demodulator 10 and a second antenna 11. The RFID device is operable using the H field i.e. near field with a range using antenna 6 (and depending on antenna configuration) of up to 1 metre.

The controller 2 controls operation of the RFID device. This controller may be a microprocessor, controller (for example a reduced instruction set computer) or state machine. The choice will depend on the design of reader used and operational requirements. The controller controls the generation of an RF signal by the signal generator 3, the timing of such a signal, response to any received modulation and the protocols under which the RFID device 1 operates. Such RF signal may, for example be at 13.56 MHz and the RFID communicator 1 may be compatible with a variety of standards or communications protocols, for example ISO/IEC 14443 or ISO/IEC 15693.

The controller interfaces with data store 4 and other functionality 17. The data store 4 may be comprised within the controller or external to the controller, it may also be comprised within a larger host apparatus (not shown) to which the RFID device 1 is interfaced or connected. Other functionality 17 may be other memory devices or may optionally or additionally comprise the functionality of a host apparatus or host device. Where other functionality comprises functionality of a host apparatus or host device, the controller may comprise an interface between the reader and such other functionality and the main control functions may be provided by the host apparatus or host device. Examples of host apparatus are given above.

The RFID device 1 in accordance with the invention has two antennas, 6 and 11. Antenna 6 is for normal near-field communication, for example in accordance with ISO/IEC 14443 or ISO/IEC 15693. The required RF signal is generated by the signal generator 3 under control of the controller 2. The RF signal may be transmitted in modulated or un-modulated form. The signal generator 2 may generate the RF signal in a variety of ways. For example the RF signal may be generated by sine synthesis resulting in a pulse-width modulated (PWM) or pulse-density modulated (PDM) digital signal. Optionally, the digital signal may be generated by use of a pre-configured algorithm or direct digital synthesis. Where sine synthesis is not used additional filtering circuitry may be required (not shown).

The digital signal generated by the signal generator 3 is fed into the differential driver 4 which outputs complementary pulses (or drive) to the antenna (6). The controller 2 will provide modulation control signals to the differential driver 4. These control signals will control at least one of the signal level and the modulation depth in accordance with the data being transmitted and the communication protocols under which the reader 1 is operating. The modulation pattern represents a series of binary ones and zeros reflecting the data to be transmitted.

The antenna 6 is shown in FIG. 1 as a tuned circuit comprising a coil 9 forming the antenna and capacitors (5, 7, 8, 19) to reduce unwanted carrier harmonics. Some of the capacitors may be omitted where the signal generated by the differential driver 4 does not exceed emissions regulations.

Where a received signal is modulated, the modulation is demodulated by demodulator 10 and the resulting signal supplied to the controller 2 determines whether and/or how to respond to the received data. The capacitors 13 and 14 are present to limit the amplitude of the signal input to the demodulator 10 and so avoid over-voltage damage to the demodulator.

Received or transmitted data may be in the form of control instructions and/or other data. The data may provide identification of an external device, and/or it may provide instructions to write certain data to the data store 15. The nature of the data provided is determined by the external device. The external device may, for example be a passive RFID transponder which derives power from the RF signal transmitted from the antenna (6) and following derivation of sufficient power then responds to the received signal by modulating that received signal. Passive in this context relates to the derivation of power by the transponder. Alternatively the external device may, for example be an active RFID transponder having its own power supply or an NFC device acting in ‘target’ inode.

In addition to the antenna 6, the reader comprises a second antenna 11. This antenna is configured to provide a different coupling configuration such as magnetic field strength and therefore range as compared to antenna 6. As with antenna 6, second antenna 11 is shown in FIG. 1 as a tuned circuit with coil 20 and capacitors 21-24. Capacitors may be added or removed as required. Typically the antenna 6 and antenna 11 are operable at different times, such operation being in accordance with control signals from the controller 2. Operation of antenna 11 may be for example as a result of control instructions received from an external device (for example an RFID tag or NFC device), control instructions stored within the controller 2 or data store 4, control instructions received from other functionality 17 (for example from a host apparatus) or may be pre-set (for example on supply of power to controller 2, antenna 11 will be turned on for a short period of time before controller switches operation to antenna 6.

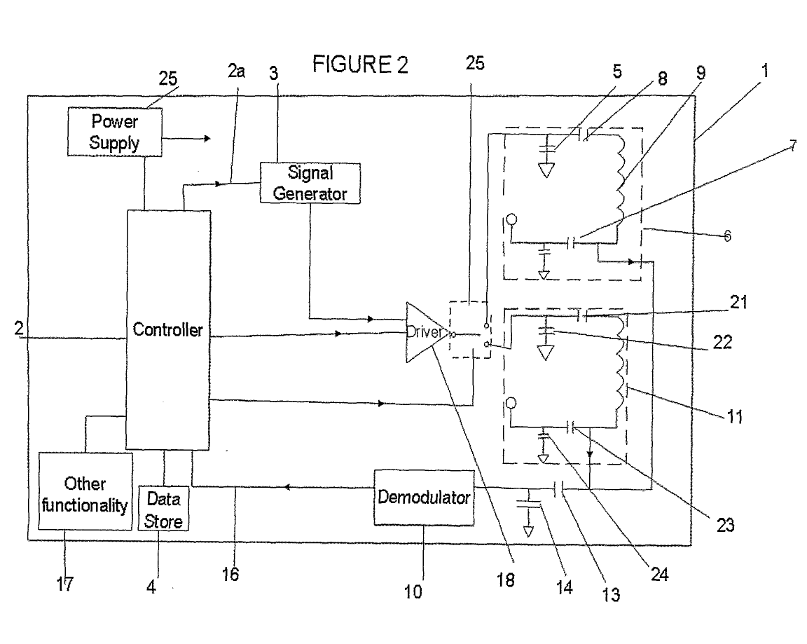

Generation of RF signals and receipt and demodulation of RF signals is the same for antenna 11 as for antenna 6. The RFID reader as shown in FIG. 1 comprises 2 differential drivers (4, 18), one for each antenna circuit. Optionally, and potentially to save silicon area, one driver may be provided for both antennas with a switch controlling which antenna is used by the driver. This arrangement is shown in FIG. 2, the same numbers have been used for equivalent functionalities. Switch 25 is used to control the antenna to which the driver outputs the RF signal. Operation of the switch is under control of the controller 2. Switch 25 may be any form of suitable switch, for example a field effect transistor (FET).

The second antenna 11 shown in FIG. 1 or 2 may be separate from the integrated circuit or reader functional components and may be attached as part of the manufacture of the overall system. Optionally, the second antenna 11 may be printed directly on to the integrated circuit or circuit board or may form part of a metal layer comprised within the integrated circuit and deposited as part of the fabrication of the integrated circuit.

In one embodiment of the invention the second antenna additionally comprises a ferrite core to provide increased directionality in the magnetic field being produced.

The RFID reader may also configure the controller (and as a result the communication protocol being used) in accordance with the antenna in use. As a result communication times (and power derivation) can be shortened by using the second antenna for specific applications and keeping the first antenna for, for example, standards compliant communication protocols.

The antennas may operate at different times or under different circumstances. Depending on the design of the second antenna it may be possible for both antennas to operate at the same time and therefore for information to be transferred to the second antenna during or immediately subsequent to communication received at the first antenna. Where the antennas are operating simultaneously the RFID reader may require multiple demodulators (one for each antenna) of the demodulator may have the capability for time-division multiplexing of the signals received from both antennas.

The RFID reader may additionally have more than two antennas, each of the plurality of antennas have a different magnetic near-field configuration or some of them having the same magnetic near-field configuration.

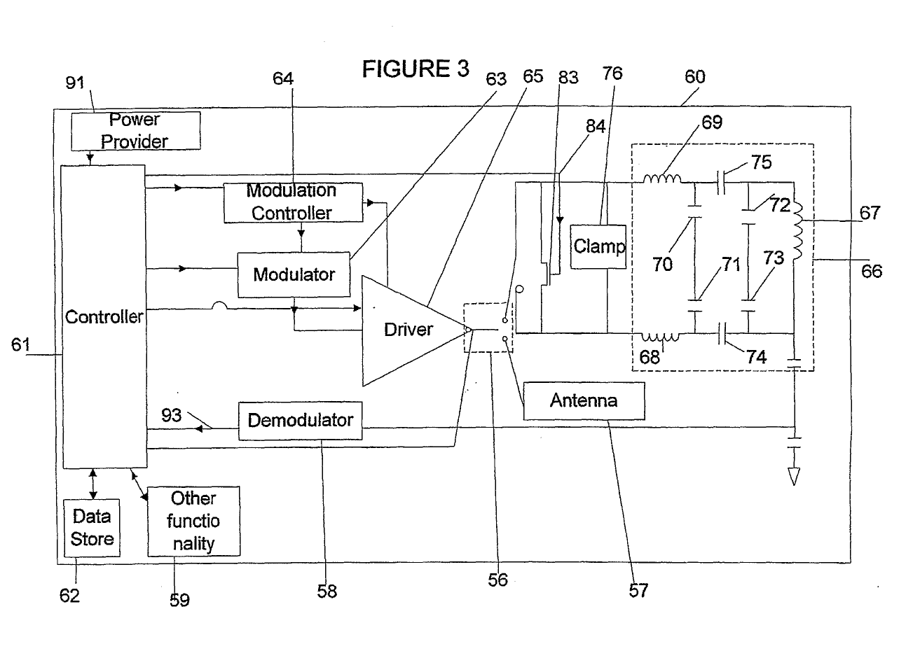

FIG. 3 shows an NFC device in accordance with an embodiment of the invention.

The NFC Device 60, unlike the reader described in FIG. 1, is capable of communicating with both transponders and other readers or NFC devices. The NFC Device 60 may operate as an initiator or target. In initiator mode, the NFC Device acts in a similar fashion to the reader described for FIG. 1 and transmits an RF signal. In target mode, the NFC device waits for receipt of an RF signal i.e. it acts more akin to a tag. Two NFC devices may communicate with each other in active or passive mode. In active mode each NFC device transmits its relevant RF signal and then ceases RF signal transmission. The other NFC device responds by transmitting its own RF signal and then ceasing RF signal transmission. In passive mode, the initiating NFC device transmits its RF signal and maintains that RF signal throughout the duration of the communication cycle. The responding NFC device causes modulation of the transmitted RF signal. Therefore passive and active in the context of NFC devices are not used to refer to the derivation of power.

The NFC Device 60 comprises a controller 61, a modulator 63, a differential driver 65, demodulator 58, data store 62, a first antenna (66), other functionality 59 and a power provider 91 (connections not shown).

The controller 61 controls operation of the NFC Device 60 in accordance with the data stored in the data store 62. The controller 51 will control RF signal generation, modulation characteristics of any transmitted RF signal, response to any received RF signal, interpretation of any received demodulated signal, mode of operation (for example initiator or target or active or passive mode) and the communication protocol under which the NFC Device 60 operates. The controller 61 may comprise a microcontroller, RISC computer or state machine.

As with the reader described for FIG. 1, the NFC Device 60 may be a stand-alone device or be comprised within a host apparatus such as a mobile telephone, printer, personal digital assistant or computer or other electrical or electronic system. Where comprised within a host system, the controller 61 may provide an interface to a host apparatus controller (represented by other functionality 59) which then is responsible for control of the NFC Device operations. Optionally, controller 61 provides some control functions and interface to the controller within the host apparatus for other control functions and/or data. Some or all of the other functional blocks shown in FIG. 3 may also be dispersed throughout the host apparatus.

When the NFC Device 60 is transmitting an RF signal (whether modulated or not) such signal transmission will be controlled by the controller 61. The NFC device 60 may comprise a modulation controller 64 separate from the controller 61, however this is not essential. The controller controls modulation of the signal via the modulation controller if present and in accordance with control data and normal data held within the controller and data store 62 (or in the alternative in accordance with data from any host apparatus). For example the modulation controller (or controller) may control the amplitude of the signal supplied by the modulator 63 to the differential driver 65. In this example, the RF signal fed by the differential driver 65 to the antenna 66 is in digital square wave form and additional filtering components (inductors and capacitors, 68, 69, 70, 71, 72, 73, 74, 75) are included within antenna 66 to ensure emission regulations are met. A clamp 76 is also provided to reduce any risk of high voltages destroying any integrated circuit.

As with the reader in FIG. 1, the NFC Device 60 additionally comprises a second antenna 57. This antenna may be in any suitable form but should be designed so as to produce a different coupling configuration such as magnetic field strength or physical shape from that produced by antenna 66. Operation of each antenna is under the control of controller 61 which operates a switch 56 controlling the direction of the signal produced by the differential driver 65. The second antenna 57 may be in the same or similar form to that shown for the first antenna 66 or to that shown in FIGS. 1 and 2 (11). It may be resonant or non-resonant.

When the NFC Device 60 is operating in passive or target mode, it awaits receipt of an RF signal at the antenna (66). The antenna is formed as a coil inductor 67. The received signal generates an ac voltage across the antenna (66) circuitry. The received signal is demodulated by the demodulator 58 and such demodulated signal fed to the controller 61 which determines the response, if any, made by the NFC Device.

In responding to a received signal, the NFC Device responds in accordance with its operational mode. Where the NFC Device is operating in active mode, it responds through the generation of a modulated signal as described above. Where the NFC Device is operating in passive mode, the NFC Device may either modulate the received RF signal directly by load modulation or through interference with the carrier signal (simulates load modulation).

The NFC device 60 will also have a power supply. Such power supply may be a battery or other device either specific to the NFC Device or comprised within a hosting apparatus or system. The NFC Device 60 may also derive either all or part of its operational power from a supplied RF field.

As with the RFID device in FIG. 1, the NFC device may comprise more than two antennas, each with a different magnetic near field coupling configuration or some may have the same magnetic near-field coupling configuration.

Illustrative examples of how embodiments in accordance with the present invention may be used will now be described. RFID or NFC devices as described above may be comprised within a host apparatus or system and used to communicate data and/or transfer power to other devices or systems external to the host apparatus or host system. Alternatively the RFID or NFC devices may be operable to communicate data and/or transfer power with different components or parts of the host apparatus or host system, whether replaceable or non-separable. In a further alternative the RFID or NFC devices may communicate data and/or transfer power with both external and internal (for example components, disposables etc) devices.

Various electrochemical energy conversion devices have also been proposed. Such devices are referred to as fuel cells below. Fuel cells provide a DC voltage through the catalytic oxidation of hydrogen into protons and electrons. Fuel cell devices include one or more fuel cells which may comprise fuel cell canisters from which fuel is drawn. The fuel cell may be configured as a cartridge from which the fuel canister or fuel cell is not removeable, or alternatively the fuel cell or fuel canister may be designed to be used as a replaceable consumable and hence be separable from the cartridge or fuel cell (as relevant). All such combinations are referred to below as fuel cell devices, and in either case it is difficult to measure the remaining fuel within fuel canister of the fuel cell device (particularly when the fuel canister is sealed within a cartridge that may be used to replace a battery).

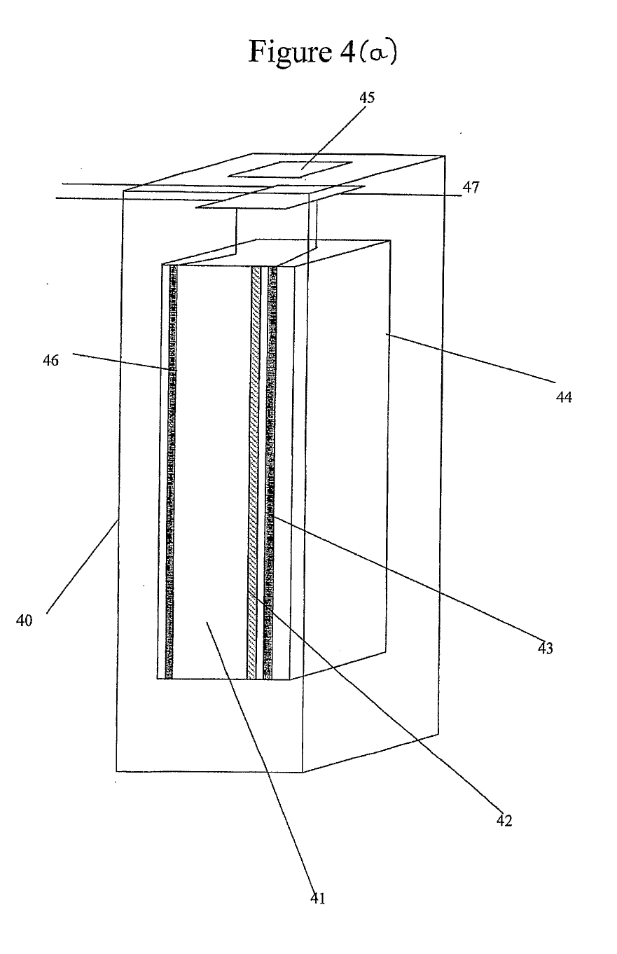

FIG. 4 shows a diagrammatic representation of a fuel cell device. The fuel cell device may be any type of electrochemical conversion device. The fuel cell device is supplied as a fuel cell cartridge 40 which contains the fuel cell 44 and a converter (47), and may also include a fuel canister (not shown). The converter acts to interface between the fuel cell and the circuit or circuits which the fuel cell is powering, for example within a mobile telephone or other electrical device. The converter will be connected to a power deriver (not shown) within the electrical apparatus being powered by the fuel cell, such connection is likely to be contact based.

The fuel cell is shown in FIG. 4 as a proton exchange membrane (PEM) fuel cell. Such cells comprise a membrane, typically a polymer membrane, sandwiched between an anode and a cathode. A hydrogen bearing fuel is supplied to the anode and a catalyst, for example platinum coated on the anode, oxidises the hydrogen component of the fuel to generate protons and electrons. The protons pass through the membrane towards the cathode, and the electrons are diverted through an external electrical circuit to provide a voltage. The cathode is supplied with oxygen (typically from ambient air), and the oxygen is reduced by the protons to form water.

The fuel cell may be supplied or filled with hydrogen. Alternatively, the cell may be supplied or filled with hydrocarbons or alcohol fuels as a source of hydrogen. For example the fuel cell device may configured to use methanol as a fuel, and in that instance the device may include a reformer to convert methanol from a methanol supply to hydrogen. Alternatively the fuel cell may be a so-called DMFC (Direct Methanol Fuel Cell) device in which case the fuel cell may be filled with methanol 41. As mentioned above, a catalyst is included to facilitate the oxidation of the hydrogen into protons and electrons, and in the case of a DMFC the catalyst may be platinum powder coated onto carbon paper or cloth.

The separated electrons will flow through the converter providing a DC voltage. The converter will record voltage produced, current flow and/or power.

The fuel cell cartridge also comprises an RFID tag 45. This RFID tag is used to record the number of times the fuel cell device is used and therefore provide information on the amount of fuel remaining or other safety information. The RFID tag acts as a memory store for the converter or alternatively an RF interface for the converter. For example the RFID tag may record whatever power measurements are made by the converter and retain a record of such measurements, and such measurements may then be used to ascertain, at least approximately, fuel cell useage and cartridge life remaining. As an illustrative example, a measure may be made of the power drawn by the system to which the fuel cell device is connected, and based on predetermined knowledge concerning (a) the amount of fuel in the cartridge, and (b) the amount of fuel required by the device to generate a unit of power, it is then possible to estimate the amount of fuel used by the device and hence the amount of fuel remaining and the associated expected lifetime of the cartridge.

The RFID tag 45 may alternatively be placed on the fuel cell or fuel cell canister, for example where the fuel cell canister is removeable or replaceable. The RFID tag 45 may also be replaced with an NFC device. The NFC device may be an NFC device such as described for FIG. 3 or alternatively an NFC device in accordance with ISO 18092 or ISO 21481.

FIG. 4(b) provides a further illustration of the REID tag 45. The antenna is shown as being separate from the tag. However, in the invention the antenna may form part of the tag integrated circuit, for example be printed onto the integrated circuit or form part of a metal layer within the fabricated integrated circuit. The tag may also comprise a ferrite core for increased directionality and to assist communication with a compatible antenna within a corresponding reader or NFC device.

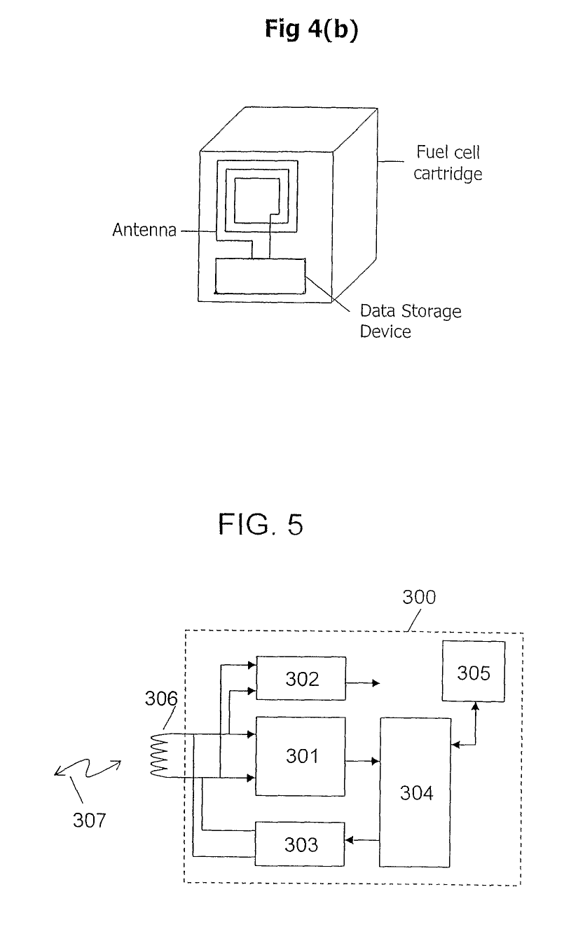

FIG. 5 illustrates the functionality found within an REID tag in accordance with an embodiment of this invention. The RFID tag 300 comprises a demodulator 301, a controller 304, a modulator 303 and memory 305. The RFID tag is attached to an antenna, shown in FIG. 5 as a coil 306. When for example an RFID reader causes a magnetic field 307 to be present around coil 306 a voltage is generated across coil 306. RFID tag 300 may or may not contain power deriver 302, which can if present, use the voltage across coil 306 to derive a power supply for all or part of RFID tag 300. If the magnetic field 306 is modulated, then demodulator 301 demodulates the signal and outputs the demodulated data to tag controller 304. Controller 304 may respond to data from demodulator 301, the presence of power from power deriving means 302, or from some other stimulus (for example temperature or other sensors), not shown, and may or may not cause data to be read from or written to the RFID or NFC device 305. The controller 304 may similarly respond to data, power or stimulus and cause data, which might be from RFID or NFC device 305, to be sent to modulator 303. Modulator 303 when receiving data from the controller 304 causes, according to the data, a modulated signal to be coupled via the magnetic field 307 to the device originally generating the field, an RFID reader in this example. Such modulation may be through load modulation of the antenna circuitry or any suitable form of modulation. Tag controller 304 might further contain user interface means or the like.

The controller 304 may be a microprocessor, state machine, microcontroller or other similar processor. The type of processor will depend on the RFID tag and functionality required, in particular the complexity of the RFID tag and any applicable cost constraints.

The memory 305 may be any suitable form of memory or combination of memory forms, for example EEPROM, flash, ROM, OTP.

The amount of processing carried out by the tag depends on the amount of processing carrier out by the converter (see 47 in FIG. 3). The converter may comprise power measurement or current or voltage measurement means but limited processing means. Processing of the measured parameter carried out in the tag, for example the controller 304 within the tag may operate an algorithm which compares the measurement against historical measurements previously received and calculates available power or life remaining within the fuel cell. The calculation is then stored within the memory 305 or within the controller 304 and can then be accessed by a compatible RFID reader. Optionally all calculations may be carried out by the converter (47 in FIG. 3) and the tag may simply store the end result. The controller 305 may in that instance only be used for communication between the converter and the tag and for communication with a compatible RFID reader.

Measurements and measurement storage by the converter and RFID tag may be constant, with a constant flow of information between tag and converter. Optionally the flow of information may be based on elapsed time or at pre-set time intervals.

The resulting data stored within the tag can then be used to communicate information on fuel cell device life to any electrical device that the fuel cell device is used to power. The data can be transferred with the fuel cell device between devices and the RF interface on the tag provides a non-contact based communication system which is not reliant on having any form of contact matching or interface slots.

The tag may be passive (i.e. not having its own power supply) or active (having its own power supply). It may derive power for data storage on fuel cell device usage directly from the converter or power provided by the fuel cell device. Where the tag is passive it may derive operational power for radio frequency communication from the magnetic field supplied from the reader or NFC device with which it communicates.

The tag may be designed to communicate with a standard RFID reader or NFC device, for example an ISO/IEC 14443 compatible reader or NFC device compatible with ISO/IEC 18092 or 21481. In one embodiment of the invention the tag is designed to communicate with a reader or NFC device in accordance with FIGS. 1-3 above i.e. a reader or NFC device with multiple antennas.

The tag antenna 306 is operable to communicate with the second antenna as described in FIGS. 1-3 above. For example the second antenna 11 in FIG. 1 is designed to provide a very small magnetic field and therefore short range. The tag antenna 306 should be designed to be compatible with the second antenna 11 and positioning of fuel cell cartridge be made accordingly. The communication between second antenna 11 and tag antenna 306 will be exclusively for the purpose of communicating fuel cell usage and therefore to provide information to the reader, and as a result to any larger host apparatus, as to when the fuel cell device may require changing.

Where the tag antenna is kept very small, the tag can likewise be kept to a minimum. This reduces overall tag costs and minimizes space requirements within the fuel cell. Where the antenna is designed to communicate directly with a specially designed antenna in the RFID reader or NFC device (as described above for second antenna 11), the tag to reader communication protocol can also be designed to minimize power requirements, time etc. It also minimizes the risk of interference with other devices.

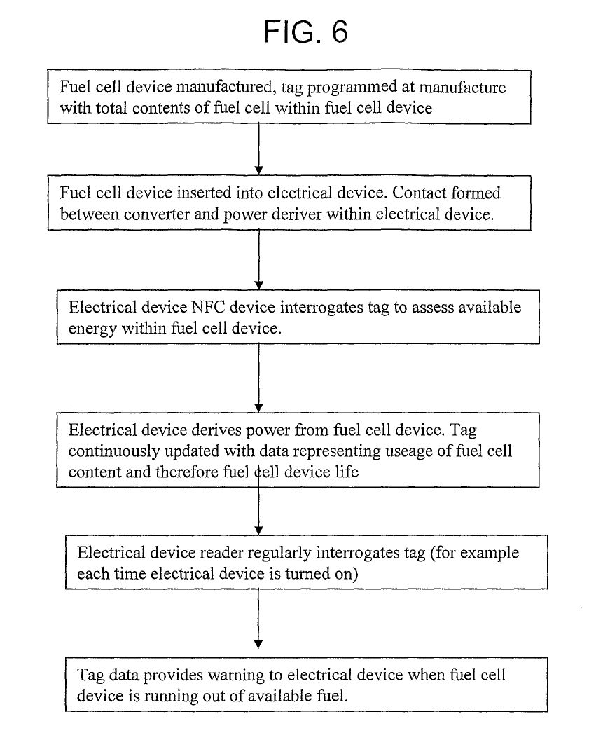

FIG. 6 provides an example flow of data between fuel cell device, tag and electrical device. On manufacture the tag will be programmed with data representing the total fuel available. Such programming may be by an RFID reader in the manufacturing line or may be on the forming of the initial contact between the tag and converter.

The fuel cell device will then be inserted into, for example a mobile telephone. On insertion the tag on the fuel cell device will come into close proximity with an antenna of an RFID reader or NFC device within the mobile telephone. Such antenna may be in the format of antenna 11 and as described above. On insertion of the fuel cell device into the mobile phone the mobile telephone processor will instruct the RFID reader or NFC device to request data on fuel cell device usage. The RFID reader will transmit a magnetic field at antenna 11, modulated with a request for identification, verification and data on fuel cell device usage. The tag (if passive) derives power from the supplied magnetic field and following derivation of sufficient power responds to the RFID reader with the requested data. The requested data may be provided, for example, through modulation of the supplied magnetic field. The RFID reader will demodulate the received modulated signal, and the RFID reader or NFC device controller passes data on the fuel cell device to the mobile telephone processor. The supply of data may result in a message being displayed to the mobile telephone user, for example “fuel cell full”.

During operation of the mobile telephone the RFID reader requests further data on fuel cell device usage. The data is provided by the tag via modulation of the magnetic field as described above. Where the fuel cell device is close to exhaustion, additional data may be provided by the tag to the RFID reader or NFC device and a warning may be issued to the user of the mobile phone. Optionally the user display may show a decreasing bar as fuel in the fuel cell device depletes.

Another application of embodiments of the present invention will now be described in relation to a remote programming system for apparatus in which various disposables, accessories and/or component parts are required for the operation of the system, and where there is a need for the end functionality of the apparatus to be controlled at the point of manufacture or supply or at some later point in the supply chain or for safety reasons.

The following illustrative example is given in the context of printers. Such printers may be any of the stand-alone or combined printers and may have many variable attachments, disposables (for example ink cartridges) or component parts.

On manufacture it may be important to control the way in which the printer may eventually function. For example if it is only designed to operate with printer cartridges of a particular type, such as black rather than colour cartridges, or the printer may need to adjust its operation to suit different types of ink (for example photo realistic colour sets) or alternatively there may be commercial reasons for controlling eventual operation of the printer. Special or pre-programmed printer cartridges (for example printer cartridges containing an ‘image’ or picture to print or itself comprising memory means holding data or instructions) may be used. Rather than programming component parts or disposables or manufacturing such component parts or disposables in such a way as to give mechanical or other functional control, this illustrative embodiment provides a way in which data and/or instructions can be programmed into the printer itself such that on activation or use of the printer, the data and/or instructions are downloaded into the printer (or printer RFID or NFC device) and thereby the functionality or operation of the printer is affected or controlled.

The data being transferred between any data storage device and any RFID or NFC device and/or the printer may be any form of data including information, program data, instructions, programs, image data, audio data.

In the embodiment described below the printer comprises a first RFID or NFC device with multiple antennas, such as that described for FIGS. 1-3 above. In addition the printer comprises a second RFID or NFC device, for example an RFID tag which is programmed during manufacture or packaging with information required for the operation of the printer. The RFID tag may be in the form described for FIG. 5 above. The RFID tag being programmed has an antenna operable to couple inductively to one of the multiple antennas comprised within the first RFID or NFC device. The two antennas have similar coupling configuration and are therefore able to couple inductively during operation. Other antennas within the first RFID or NFC device which have a different coupling configuration are then used for communication with external apparatus or for communication with the consumables used within the printer.

The second RFID or NFC device programmed during manufacture of packaging must be ‘readable’ through the packaging or wrapping used for the printer on which or within which the RFID or NFC device is comprised.

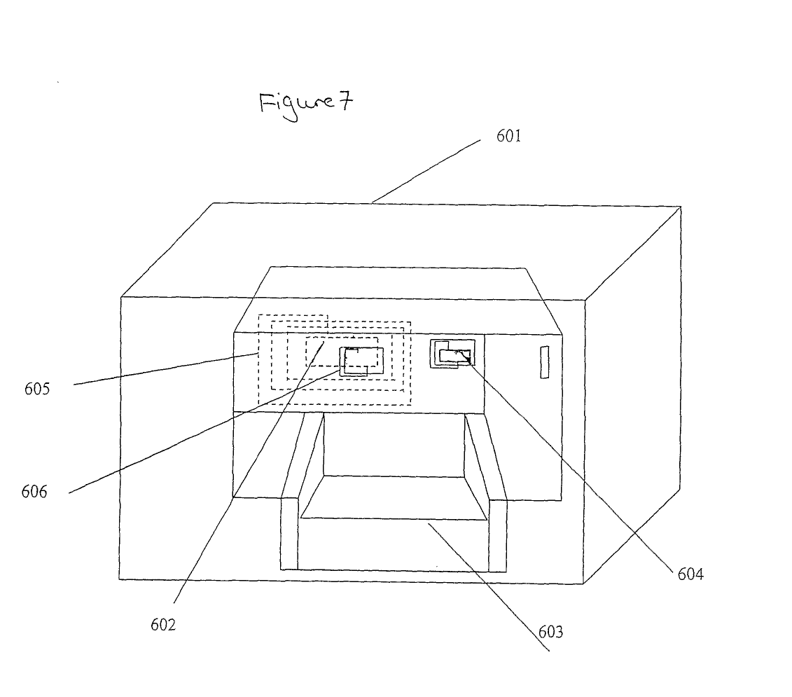

FIG. 7 illustrates a particular embodiment of the invention. RFID or NFC device 602 are comprised within the printer (end system) 603. The printer is contained within its packaging 601 ready for shipment to appropriate vendors of the printer. The printer also comprises an RFID tag 604. At the end of the packaging process or subsequent to such process, the RFID tag 604 is programmed, for example through the use of RF signals transmitted by a further RFID or NFC Device (not shown). Such RF signal will be modulated with the required data or instructions.

The RFID device or NFC device 602 are, for example, in the form of the RFID devices and NFC devices described above in FIGS. 1 and 3. The RFID device or NFC device 602 comprises two antennas (or alternatively more than two antennas), shown in FIG. 7 as 605 and 606. Antenna 606 has a magnetic near field configuration compatible with the magnetic near field configuration of the antenna on RFID tag 604, thus permitting inductive coupling between the two devices. The second antenna 605 has a different magnetic near field configuration and is not operable to couple with RFID tag 604.

Once the RFID tag 604 has been programmed, the printer 603 is then shipped to its destination and finally to an end user. When the printer is turned on data/instructions or information is transferred from the RFID tag 604 to the RFID or NFC device 602 via antenna 606. Such transfer could occur in a number of ways. For example when power is supplied to the RFID or NFC device 602, the RFID or NFC device may then emit an RF field from antenna 606, powering the data storage device 604 (where data storage device does not have its own power supply) and culminating in transfer of information from the data storage device 604 to the RFID or NFC device 602.

As a result of the information transferred or instructions provided by the data storage device to the RFID or NFC device, the printer or RFID or NFC device is thereby configured to operate or function in a particular way. For example, the RFID or NFC device may be configured to recognise only certain types of consumable or the printer may be configured to adjust the inking operation to suit the particular type of ink being supplied as a result of data received by the RFID or NFC device during operation. For example where antenna 605 is operable to have a magnetic near field coupling configuration consistent with that of a RFID tag on a disposable ink cartridge, depending on prior data received through inductive coupling between RFID tag 604 and RFID or NFC device 602, the printer may reject the ink cartridge after data communication between the ink cartridge RFID tag and the RFID or NFC device 602.

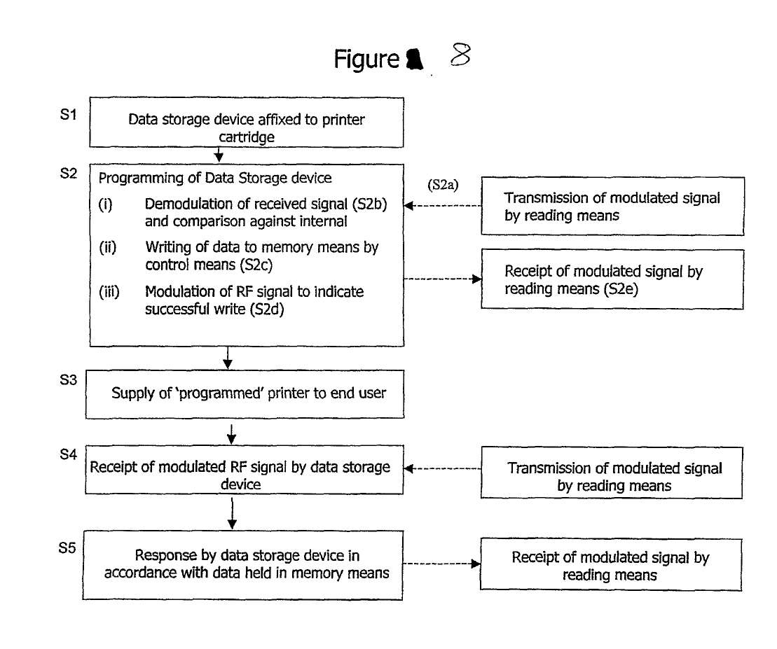

FIG. 8 illustrates the process steps in a flow diagram. Following manufacture of a RFID tag (for example an RFID tag similar to that described above for FIG. 5), the RFID tag will be affixed to the manufactured printer cartridge (S1). Such RFID tag could for example be an ISO 14443 compatible transponder programmed or used in accordance with the described invention. Alternatively the RFID tag could be an NFC device as described in ISO 18092. The RFID tag may be affixed to the external casing of the printer, the device itself may be internal to the printer with the antenna externally mounted or alternatively the whole device (including antenna) may be internal to the printer cartridge. The RFID tag may also additionally comprise sensing means or other functional means within the printer.

In another embodiment, two or more antennas may be utilised to enable the RFID tag to communicate or respond to different RF signals (whether from separate sources at the same frequency or at different frequencies). For example, one frequency may be used during manufacture and a second frequency used during printer operation. In one embodiment that RFID tag may be an NFC device as described in FIGS. 1-3 above.

The RFID tag is then ‘programmed’ with the required or desired details (S2). Such programming may occur at point of manufacture, on supply, by a supplier or alternatively at several steps in the supply chain. Different levels within the chain may have different access privileges to write-to or ‘program’ the RFID tag. As described above, this may be achieved through the use of different memory areas within the memory means in the RFID tag or through a pin number or a write-protect system.

Programming may occur through the use of an RFID or NFC device. The RFID or NFC device may transmit a modulated RF signal to the RFID tag on the printer cartridge (S2a). Such RF signal may be modulated, for example, with an instruction to write certain data to the memory means within the RFID tag. Depending on whether the RFID tag has its own power supply, the RF signal may also supply power to the RFID tag. On receipt of the modulated RF signal, the signal will be demodulated by, for example demodulation means, as described above and sent to the control means within the RFID tag. The RFID tag will check (using internal algorithms) whether any pin numbers or required security data matches (S2b) and will then write the data to its memory means (S2c). Following a successful write, the RFID tag may modulate the incoming RF signal to indicate such successful write (S2d). This modulated signal will be received by the RFID or NFC device (S2e), demodulated and sent to the control means within such RFID or NFC device. Receipt of a successful write may result in further communication between RFID or NFC device and RFID tag or alternatively the RFID or NFC device may terminate supply of the RF signal. Where the RFID tag is passive (i.e. without its own power supply source) this will result in a power down of the RFID tag.

The packaged printer with its programmed RFID tag will then be supplied eventually to an end user (S3).

In one embodiment, on powering up of the printer the RFID or NFC device within the printer will be activated. Such RFID or NFC device will then emit an RF field modulated at a first antenna with, for example, a request for response from any RFID tag able to respond and with a compatible magnetic near field coupling configuration. Where the RFID tag, is passive, the emission of the RF field by the RFID or NFC device will result in the powering up of the RFID tag. The RFID tag will receive the modulated RF signal from the RFID or NFC device (S4), demodulate the received signal and respond in accordance with the data held in its memory means (S5). Data may be transferred in one communication cycle or in a number of communication cycles depending on the operation of the RFID tag and RFID or NFC device.

For example such response may be the modulation of the received RF signal with an instruction to the RFID or NFC device such that only disposables or consumables of a particular type can be recognised by the printer. Such instruction will be received by the RFID or NFC device, demodulated and then dealt with by the control means in accordance with the type of RFID or NFC device involved. For example, the instruction may be stored within the memory of the RFID or NFC device and may comprise the need to verify any received identification codes against an internal look-up table held within the memory means.

A disposable or consumable containing its own programmed RFID or NFC device may then inserted into the printer machine. The now programmed RFID or NFC device may communicate with the RFID or NFC device on the disposable or consumable (using either the same antenna as used for communication with the printer RFID tag or using a second antenna with a different coupling configuration) and request verification of the identity of the disposable or consumable. Where such verification is not provided, or is not provided within certain time periods, then the RFID or NFC device may send a signal to the printer processor such that the printer processor controls emission of a warning signal or failure message.

In one embodiment, the two antennas may be used to discriminate between the various different RFID tags able to be read at any one time. The NFC or RFID device will select the antenna with the required coupling configuration, thereby ensuring only compatible RFID tags are communicated with.

A system such as that described above may be used both to control the operation of the printer but also potentially to prevent operation of the printer where a user tries to insert the wrong disposable/consumable or a disposable/consumable without the correct operating parameters.

Another illustrative example will now be described.

This example relates to a method and apparatus for derivation of power and/or communication of data via contactless coupling of a fluid containing container or cartridge (for example an ink cartridge) to a second device or end system (for example a printer or printing device). In this example one of the two antennas within the RFID or NFC device of the invention is used to provide power to the fluid containing container or cartridge. Supply of data may or may not occur. Other antennas within the RFID or NFC device will then be used for data communication with other compatible devices.

Many systems use corrosive or conductive fluids or materials. Such systems may also use connections between different sub-systems. Where such connections are contact based they will only function where the contact is maintained.

For example, ink cartridges utilise contact-based electrical connections between the ink cartridge (including ink-jet head and heating element) and the printer. The ink within the cartridge is both corrosive and conductive. It is important to ensure that none of the ink comes into contact with the electrical connections during operation. An additional problem in such systems is the need to align the connections on both ink cartridge and printer to ensure the connection is maintained though-out use. Should the ink cartridge be incorrectly fitted or should it move during operation then the contact may be lost. The user must also avoid touching the electrical connections during fitting and alignment of the cartridge, making accurate alignment more difficult.

In the context of printing systems, the above problems are currently minimised as a result of (a) the positioning of the ink-jet head as compared to the electrical connections on the ink cartridge and (b) the positioning of the cartridge within the end printer system such that gravity ensures the ink falls away from the electrical connections. Such positioning solutions do not enable flexibility in the use of the cartridge and do not solve the difficulties of mechanical alignment. Such solutions are also not of any use where mechanical constraints or design constraints mean the ink cartridge can not be placed in an optimal position.

Although the following description is in the context of printers or other printing devices. It should be clear to the skilled man that embodiments of the invention may also be used in similar systems where the same problem(s) exists. For example, an embodiment of the invention may be used in any system in which ink or other corrosive fluid is expelled and where there is a need for power or data transfer within the system or between the system and the fluid container.

The printers or printing devices may, for example, be any conventional printer or printing system or printer device which contains ink cartridges. Such ink cartridges may be disposable or not. In a typical embodiment the ink cartridges are disposable and are replaceable when the ink is used up or for some other reason requires replacing or swapping with a second or alternative ink cartridge.

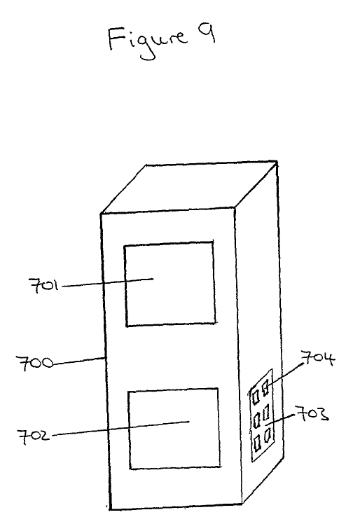

FIG. 9 illustrates a conventional ink cartridge for use within a printing device. The illustration is intentionally not to scale and intended to provide an overview of the ink cartridge. The ink cartridge 700 has an ink-jet head 701 though which ink is expelled or ejected. Ink is only expelled where it has been heated sufficiently. Ink is heated under control of a silicon heating circuit or control circuit 702. Power for the control circuit and heating process is provided from the printer system (not shown in FIG. 9) through electrical contacts 704 on a flexi-circuit 703. This flexi-circuit is positioned so as to minimise any ink spillage on the contacts. The contacts 704 mate with equivalent contacts on the printer system and power is supplied via the contacts so formed. Ink cartridges may have single ink-jet heads or multiple ink-jet heads. Example ink-jet heads may have a heater resistance around 30-50Ω, and require a 12V pulse for a period of ˜4 μS in order to eject a single drop of ink. Multiple ink-jet heads will obviously have a higher total power requirement and may increase the number of electrical contacts 704 required.

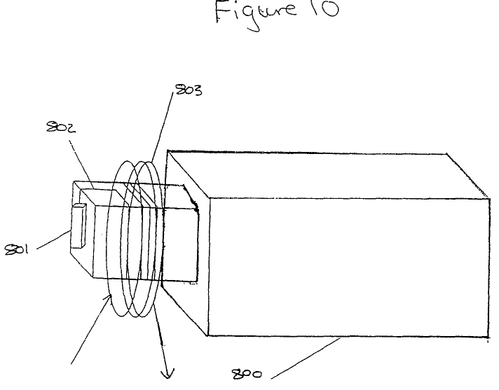

In a first embodiment in accordance with this aspect of the invention the need for electrical contacts between the ink cartridge and the printer system for the supply of power is removed. Instead inductive coupling means are provided. Such means are illustrated in FIG. 10.

In FIG. 10, the ink cartridge is represented as 800. The ink cartridge is shaped in two parts, an ink reservoir and a thinner protruding end on which is mounted the ink-jet head 801. The ink-jet head also includes the silicon circuit controlling heating of the ink. In an optional embodiment the silicon heating control circuit may be separate from the ink-jet head. The ink cartridges may be of any size and shape and may, for example, be custom designed to fit into particular areas of an end printer system or printing device. This illustrative example allows increased flexibility in design as it does not require contact mating between the printer and cartridge and also does not rely on gravity to maintain separation between the expelled ink and the contact portion of the ink cartridge.

A wire-wound coil 802 is wound around the cartridge shaft and connected to the ink-jet head. This coil may be over-moulded or epoxy coated or coated or comprised within some other form of protective coating. Such coating or overall shape may also be designed to allow easy fitting of the ink cartridge into the end printing system or device.

The cartridge shaft fits into a second coil comprised within the end printer system or printing device 803. This second coil is connected to a power supply within the end system and forms one of a plurality of antennas (or coils) of an RFID or NFC device such as that described for FIGS. 1-3 above. For ease, the RFID or NFC device is not shown in FIG. 10. The first coil is designed to have a compatible magnetic near field coupling configuration to the second coil or antenna within the RFID or NFC device in the end system. The power supply may be specific to the inkjet head or may be the main power supply for the printer or printing device. For example the power supply may be mains power or may be a battery.

Power is transferred inductively between the ink cartridge and printer system or printing device via the two coils (802 and 803).

In FIG. 10 the second coil is shown wrapped around the first coil. It should be clear to the skilled man that other coupling configurations are possible. For example the second coil 803 could be held just on one side (or above or below) the first coil 802, or the first coil may be mounted on top of the ink cartridge rather than wrapped around a protrusion from the ink cartridge. The second coil 803 may also be comprised within some form of protective coating or over moulding. The coils need not be visible or printed on the outside of the area in which the ink cartridge is or is to be situated. The coils may in an alternative not be in coil form but in, for example, figure of 8 form.

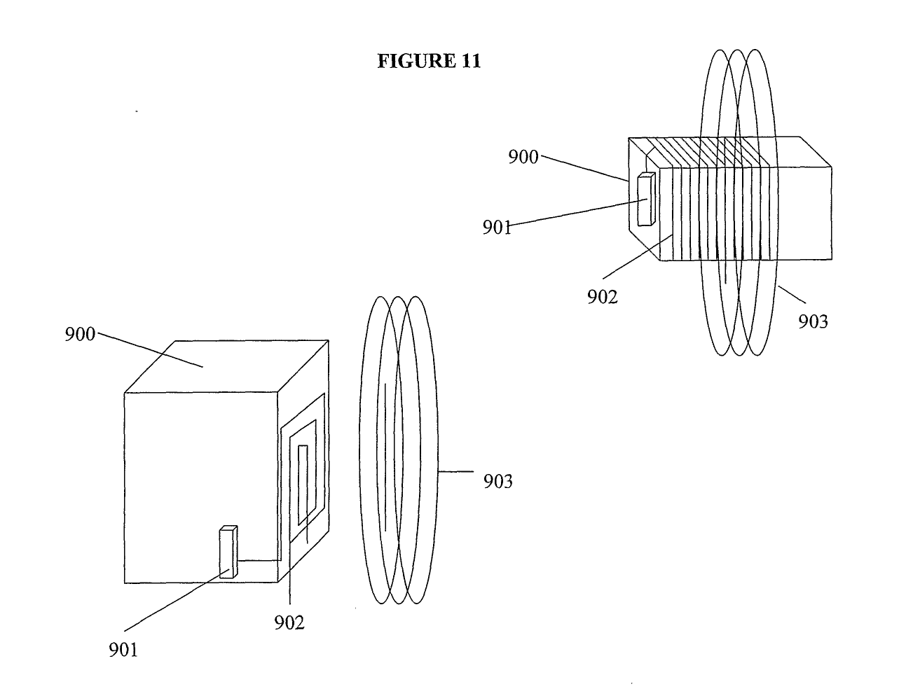

Examples of alternative coil arrangements are shown in FIG. 11. Connection of second coil to power supply/end system is not shown for ease of reference. In each example 900 is the printer cartridge, 901 is the inkjet head with silicon control circuit, 902 is the first coil and 903 is the second coil. The second coil 903 forms part of an RFID or NFC device comprising multiple coils or antennas. Multiple coupling means may also be included on the ink cartridge for example where the coupling is also being used to transfer data and/or instructions (see below), multiple antennas may be provided where some are designated for transfer of data and/or instructions and others for transfer of power. As a result coupling configurations can be optimised for power transfer or data transfer. Where data transfer is required the first coil 902 is connected to a second RFID or NFC device, for example an RFID tag as described in FIG. 5 above

The position of the coil and the protective coating used may affect the range of operation and therefore the amount of power that can be transferred between the two coils. Direct contact is not necessary and therefore accurate positioning of the ink cartridge within the printer is not necessary. It may be that in designing the printer, a pocket or enclosure or other mechanical means is designed for the ink cartridge such that variations in range between the two coils can be minimised.

In one embodiment the co-location of the coils effectively creates a transformer which is used to generate a drive pulse of higher voltage within the heating circuit and therefore to expel ink through the inkjet head. Depending on the system in question and the nature of the transformer created by the co-location of the coils, it may be necessary to compensate for the inkjet drive pulse length or shape for the AC nature of the drive signal.

In a further embodiment ferrite or some other magnetic material may be co-located with either coil thereby increasing the magnetic coupling between the two coils and the amount of power transferred.

In another embodiment the inductive coupling means is combined with a small electronic circuit used to convert the AC signal into a local DC supply rail. For example, a rectifier and capacitor may be added to bring about such conversion. The use of such conversion may result in a minimisation of connections required in multiple-nozzle head systems.

Where the inductive coupling between RFID devices is used to provide both power and to communicate data, additional functionality can be provided, for example control of which ink-jet head is used where multiple ink-jet heads are used within a system. Such a system may also avoid cost and reliability problems associated with multiple contacts on high resolution print heads

In the application examples provided above RFID devices and NFC devices may be stand-alone or incorporated within host apparatus or host system functionality. They may affect operation of the host apparatus or host system or affect operation of only a part of the host apparatus or host system. It will be apparent from the foregoing that several different embodiments of RFID devices are possible and the devices described are given by way of illustration only. It will further be understood, and should be noted, that modifications, substitutions and additions may be made to the particular embodiments described without departing from the spirit and scope of the invention.

For example, further aspects and embodiments of the invention are enumerated in the following numbered clauses.
1. An electrical system comprising a RFID tag and a RFID or NFC device wherein such RFID tag can be programmed during or after manufacture and wherein such RFID or NFC device, on supply of power, is adapted to read or communicate with the RFID tag such that data and/or instructions transferred from the RFID tag affect the operation of, functionality or performance of the system.
2. An electrical system according to clause 1, where such electrical system is a consumer device, for example a printer.
3. An electrical system according to clause 1 or 2, wherein such RFID tag is an RFID device and such RFID or NFC device is also an RFID device.
4. An electrical system according to any one of clause 1 to 3, wherein such RFID tag does not comprise its own power supply.
5. An electrical system according to clause 1 wherein following transfer of data and/or instructions from the RFID tag to the RFID or NFC device, the RFID tag is rendered inoperable or non-functional.
6. An electrical system according to clause 1 which additionally comprises a further RFID or NFC device separate from the electrical system, such separate RFID or NFC device being adapted to program the RFID tag.

For the avoidance of doubt, where in the description and claims reference is made to the generation of a near-field of a particular type by a coupling member, coil or antenna for example, it is also intended to refer to such coupling member, coil or antenna being responsive to an incident near-field of such a type due to the principle of reciprocity in electromagnetism.

A final point of note is that whilst certain combinations of features have been identified in the description, the scope of the present invention is not limited to those combinations and instead extends to encompass any combination of features herein described irrespective of whether or not that particular combination has been explicitly enumerated in the description.

1-26. (canceled)

27. A wireless near-field communications device, comprising a first and a second near-field inductive coupling member, each of said first and second coupling member arranged to have a different coupling configuration from each other.

28. The device according to claim 27, said first coupling member arranged to generate a near-field having a different orientation relative to a near-field generated by said second coupling member.

29. The device according to claim 28, said first coupling member arranged to generate a near-field having an orientation transverse, orthogonal or opposed to a near-field generated by said second coupling member.

30. The device according to claim 27, said first coupling member arranged to generate a different magnetic near-field configuration from a magnetic near-field configuration generated by said second coupling member.

31. The device according to claim 27, said first coupling member disposed spatially distant from said second coupling member.

32. The device according to claim 27, said first coupling member arranged to generate a near field having a different near field coupling distance relative to a near field generated by said second coupling member.

33. The device according to claim 32, wherein said second coupling member is configured to have a maximum near field coupling distance of up to 1 centimetre.

34. The device according to claim 27, wherein said wireless near-field communications device is an NFC device.

35. The device according to claim 27, wherein said wireless near-field communications device is an RFID reader.

36. Apparatus comprising:
a wireless near-field communications device, comprising a first and a second near-field inductive coupling member, each of said first and second coupling member arranged to have a different coupling configuration from each other; and
a second wireless near-field communications device.

37. Apparatus according to claim 36 wherein the first coupling member is arranged to a have a configuration compatible with a complementary coupling member of the second wireless near-field communications device.

38. Apparatus according to claim 37, said device positioned in said apparatus such that said second coupling member is operative to communicate with said complementary coupling member.

39. Apparatus according to claim 36, said apparatus comprising a host part and a component part, said host part including said wireless near-field communications device and wherein said device is positioned in said host part such that said second coupling member is operative to couple with a complementary coupling member supported by said component part.

40. Apparatus according to claim 39, wherein said component part is removable from said apparatus.

41. Apparatus according to claim 40, wherein said component part is replaceable.

42. Apparatus according to claim 39, wherein said component part comprises a consumable item for said apparatus.

43. Apparatus according to claim 39, wherein said component part comprises an accessory for the host part.

44. Apparatus according to claim 39, wherein said component part is a spare part for said apparatus.

45. Apparatus according to claim 39, wherein the apparatus is an electrical device and the component part is a fuel cell device.

46. Apparatus according to claim 39, wherein the apparatus is a printer and the component part is an ink cartridge.

47. Apparatus according to claim 36, wherein the apparatus is one of a printer, a mobile telephone, a personal computer.

48. Apparatus according to claim 36, wherein said first coupling member is operative to communicate with a wireless near-field inductive coupling device external to said apparatus.

49. A wireless near-field inductive coupling communications system comprising apparatus according to claim 39, wherein said component part includes a device according to claim 27.

50. The wireless near-field inductive coupling communications system comprising apparatus according to claim 48 and a wireless near-field inductive coupling device external to said apparatus.

51. The system according to claim 50, wherein one or other or both of said devices are configured to provide for power transfer between them.
